(19) United States
(12) Patent Application Publication
(10) Pub. No.: US 2008/0079781 A1
(43) Pub. Date: Apr. 3, 2008

(54) INKJET PRINTHEAD AND METHOD OF MANUFACTURING THE SAME

(75) Inventors: Dong-sik Shim, Yongin-si (KR); Yong-seop Yoon, Yongin-si (KR); Moon-chul Lee, Yongin-si (KR); Chan-bong Jun, Yongin-si (KR); Hyung Choi, Yongin-si (KR); Yong-won Jeong, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/742,792

(22) Filed: May 1, 2007

(30) Foreign Application Priority Data
Oct. 2, 2006 (KR) 2006-97414

(51) Int. Cl. B41J 2/05; G11B 5/127

(52) U.S. Cl. 347/63; 216/27

(57) ABSTRACT

An inkjet printhead and a method of manufacturing the same. The inkjet printhead may include a substrate through which an ink feed hole to supply ink is formed, a chamber layer stacked above the substrate and including a plurality of ink chambers filled with ink supplied from the ink feed hole, and a nozzle layer stacked on the chamber layer, wherein a plurality of nozzles through which ink is ejected and a plurality of via holes are formed in the nozzle layer.

### CROSS-REFERENCE TO RELATED APPLICATIONS

This application claims priority under 35 U.S.C. §119(a) Korean Patent Application No. 10-2006-0097414, filed on Oct. 2, 2006, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of manufacturing the same, and more particularly, to a thermal inkjet printhead that can be manufactured using a simplified process.

2. Description of the Related Art

Inkjet printheads are devices used to form images on printing mediums by ejecting droplets of ink onto a desired region of a corresponding printing medium. Inkjet printheads can be classified into two types depending on the ink ejecting mechanism: thermal inkjet printheads and piezoelectric inkjet printheads. The thermal inkjet printhead generates bubbles in ink by using heat and ejects the ink utilizing an expansion force of the bubbles, and the piezoelectric inkjet printhead ejects ink using a pressure generated by a deformation of a piezoelectric material.

The ink droplet ejecting mechanism of the thermal printhead will now be further described. When a current is applied to a heater formed of a resistive heating material, heat is generated from the heater to rapidly increase a temperature of ink adjacent to the heater to about 300° C. As a result, bubbles are generated in ink and, as the bubbles expand, a pressure of ink filled in an ink chamber of the thermal printhead increases. Thus, the ink is pushed out of the ink chamber through a nozzle in the form of droplets.

FIG. 1 is a schematic sectional view illustrating a conventional thermal inkjet printhead. Referring to FIG. 1, the conventional inkjet printhead includes a substrate 10 on which a plurality of material layers are stacked, a chamber layer 20 formed above the substrate 10, and a nozzle layer 30 located on the chamber layer 20. The chamber layer 20 includes a plurality of ink chambers 22 filled with ink. The nozzle layer 30 includes a plurality of nozzles 32 for ejecting ink. An ink feed hole 11 is formed through the substrate 10 to supply ink to the ink chambers 22. The chamber layer 20 further includes a plurality of restrictors 24 that connect the ink chambers 22 with the ink feed hole 11.

An insulating layer 12 is formed on the substrate 10 to insulate the substrate 10 from a plurality of heaters 14. The heaters 14 are formed on the insulating layer 12 to create bubbles by heating the ink filled in the ink chambers 22. Electrodes 16 are formed on the heaters 14. A passivation layer 18 is formed on the heaters 14 and the electrodes 16 to protect the heaters 14 and the electrodes 16. Anti-cavitation layers 19 are formed on the passivation layer 18 to protect the heaters 14 from cavitation forces generated when bubbles collapse.

In a conventional method of manufacturing the above-described inkjet printhead, the chamber layer 20, including the ink chambers 22, is formed and a sacrificial layer is filled in the ink chambers 22. Next, an upper surface of the sacrificial layer is planarized using a chemical mechanical polishing (CMP) process, and then the nozzle layer 30 is formed on the planarized sacrificial layer. However, the forming of the sacrificial layer and the CMP process are time consuming and expensive. Also, the CMP process is difficult for accurately controlling a thickness of the chamber layer 20. In addition, since the sacrificial layer is removed by injecting a predetermined solvent through the nozzles 32 and the ink feed hole 11, it takes considerable time to remove the sacrificial layer.

### SUMMARY OF THE INVENTION

The present general inventive concept provides a thermal inkjet printhead that can be manufactured using a simplified process, and a method of manufacturing the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead including a substrate through which an ink feed hole to supply ink is formed, a chamber layer stacked above the substrate and including a plurality of ink chambers filled with ink supplied from the ink feed hole, and a nozzle layer stacked on the chamber layer, wherein a plurality of nozzles through which ink is ejected and a plurality of via holes are formed in the nozzle layer.

The via holes may be located above the ink feed hole.

The foregoing and/or other aspects and utilities of the present general inventive concept may also be achieved by providing a method of manufacturing an inkjet printhead, the method including preparing a substrate, forming a chamber material layer above the substrate, disposing a first photomask including an ink chamber pattern above the chamber material layer and exposing the chamber material layer to form a chamber layer defining a plurality of ink chambers in the chamber material layer, forming a nozzle material layer on the exposed chamber material layer, disposing a second photomask including a nozzle pattern above the nozzle material layer and exposing the nozzle material layer to form a nozzle layer defining a plurality of nozzles in the nozzle material layer; etching the substrate from a rear surface of the substrate such that a bottom surface of the chamber material layer is exposed to form an ink feed hole, and removing the chamber material layer in the ink chambers and the nozzle material layer in the nozzles with a developer.

The foregoing and/or other aspects and utilities of the present general inventive concept may also be achieved by providing a method of manufacturing an inkjet printhead, the method including, preparing a substrate, forming a chamber material layer above the substrate, disposing a first photomask including an ink chamber pattern above the chamber material layer and exposing the chamber material layer to form a chamber layer defining a plurality of ink chambers in the chamber material layer, forming a nozzle material layer on the exposed chamber material layer, disposing a second photomask including a nozzle pattern and a via hole pattern above the nozzle material layer and exposing the nozzle material layer to form a nozzle layer defining a plurality of nozzles and a plurality of via holes in the nozzle material layer, etching the substrate from a rear surface of the substrate such that a bottom surface of the chamber material layer is exposed to form an ink feed hole, and removing the chamber material layer in the ink chambers and the nozzle material layer in the nozzles and the via holes with a developer.

The foregoing and/or other aspects and utilities of the present general inventive concept may also be achieved by providing a method of manufacturing an inkjet printhead, the method including, preparing a substrate, forming a chamber material layer above the substrate, forming a nozzle material layer on the chamber material layer, disposing a first photomask including an ink chamber pattern above the nozzle material layer and exposing the nozzle material layer and the chamber material layer to form a chamber layer defining a plurality of ink chambers in the chamber material layer, disposing a second photomask including a nozzle pattern above the nozzle material layer and exposing the nozzle material layer to form a nozzle layer defining a plurality of nozzles in the nozzle material layer, etching the substrate from a rear surface of the substrate such that a bottom surface of the chamber material layer is exposed to form an ink feed hole, and removing the chamber material layer in the ink chambers and the nozzle material layer in the nozzles with a developer.

The foregoing and/or other aspects and utilities of the present general inventive concept may also be achieved by providing a method of manufacturing an inkjet printhead, the method including, preparing a substrate, forming a chamber material layer above the substrate, forming a nozzle material layer on the chamber material layer, disposing a first photomask including an ink chamber pattern above the nozzle material layer and exposing the nozzle material layer and the chamber material layer to form a chamber layer defining a plurality of ink chambers in the chamber material layer, disposing a second photomask including a nozzle pattern and a via hole pattern above the nozzle material layer and exposing the nozzle material layer to form a nozzle layer defining a plurality of nozzles and a plurality of via holes in the nozzle material layer, etching the substrate from a rear surface of the substrate such that a bottom surface of the chamber material layer is exposed to form an ink feed hole, and removing the chamber material layer in the ink chambers and the nozzle material layer in the nozzles and the via holes with a developer.

The foregoing and/or other aspects and utilities of the present general inventive concept may also be achieved by providing a method of manufacturing an inkjet printhead, the method including preparing a substrate, forming a chamber material layer on the substrate, forming a nozzle material layer above the chamber material layer, exposing the chamber material layer and the nozzle material layer to form a chamber layer and a nozzle layer respectively, etching the substrate to form an ink feed hole, and removing excess chamber material layer and nozzle material layer with a single development process to form ink chambers and nozzles.

The exposing of the chamber material layer and the nozzle material layer may include disposing a first photomask above the chamber material layer and exposing the chamber material layer to form a chamber layer defining a plurality of ink chambers, and disposing a second photomask above the nozzle material layer and exposing the nozzle material layer to form a nozzle layer defining a plurality of nozzles, and the nozzle material layer may be formed above the exposed chamber material layer.

The exposing of the chamber material layer and the nozzle material layer may include disposing a first photomask above the nozzle material layer and exposing the nozzle material layer and the chamber material layer to form a chamber layer defining a plurality of ink chambers in the chamber material layer, and disposing a second photomask above the nozzle material layer and exposing the nozzle material layer to form a nozzle layer defining a plurality of nozzles.

A time of exposure may be controlled such that only the nozzle material is exposed when exposing the nozzle material layer to form a nozzle layer defining a plurality of nozzles.

A light transmittance of the nozzle material layer and the chamber material layer may be such that only the nozzle material is exposed when exposing the nozzle material layer to form a nozzle layer defining a plurality of nozzles.

The exposing of the nozzle material layer to form a nozzle layer defining a plurality of nozzles may also define a plurality of via holes between the nozzles.

The plurality of via holes may be formed above the ink feed hole to allow faster removal of the excess nozzle material layer and chamber material layer.

The exposing of the nozzle material layer to form a nozzle layer defining a plurality of nozzles may also define a plurality of via holes to allow faster removal of the excess nozzle and chamber material layer during the development process.

The preparing of the substrate may include forming the substrate, forming an insulating layer on the substrate, forming a plurality of heaters on the insulating layer, and forming a plurality of electrodes on the heaters.

The foregoing and/or other aspects and utilities of the present general inventive concept may also be achieved by providing a method of manufacturing an inkjet printhead, the method including preparing a substrate, forming a chamber material layer having a first light transmittance on the substrate, forming a nozzle material layer having a second light transmittance above the chamber material layer, exposing the chamber material layer and the nozzle material layer to form a chamber layer and a nozzle layer respectively, etching the substrate to form an ink feed hole, and removing excess chamber material layer and nozzle material layer with a single development process to form ink chambers and nozzles.

The exposing of the chamber material layer and the nozzle material layer may include disposing a first photomask above the nozzle material layer and exposing the nozzle material layer and the chamber material layer to form a chamber layer defining a plurality of ink chambers in the chamber material layer, and disposing a second photomask above the nozzle material layer and exposing the nozzle material layer to form a nozzle layer defining a plurality of nozzles, and a time of exposure may be controlled such that only the nozzle material is exposed when exposing the nozzle material layer to form a nozzle layer defining a plurality of nozzles.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic sectional view illustrating a conventional inkjet printhead;

FIG. 2 is a schematic plan view illustrating an inkjet printhead according to an embodiment of the present general inventive concept;

FIG. 3 is a sectional view illustrating the inkjet of FIG. 2 taken along line III-III′;

FIG. 4 is a view illustrating a nozzle layer that can be used for an inkjet printhead according to an embodiment of the present general inventive concept;

FIGS. 5 through 12 are views illustrating a method of manufacturing an inkjet printhead according to an embodiment of the present general inventive concept;

FIGS. 13 through 16 are views illustrating a method of manufacturing an inkjet printhead according to another embodiment of the present general inventive concept;

FIGS. 17 through 22 are views illustrating a method of manufacturing an inkjet printhead according to another embodiment of the present general inventive concept; and

FIGS. 23 through 26 are views illustrating a method of manufacturing an inkjet printhead according to yet another embodiment of the present general inventive concept.

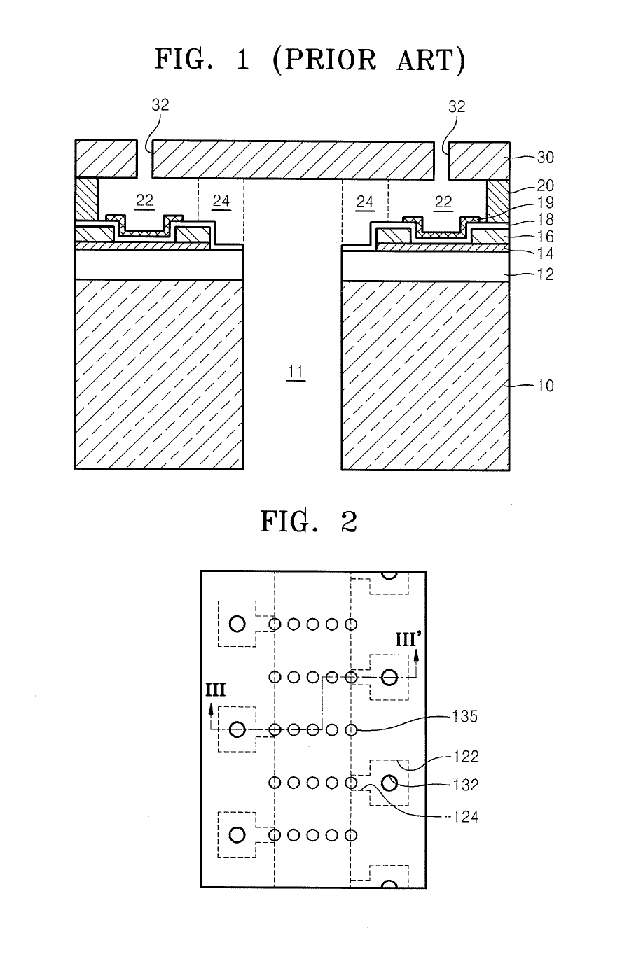

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. The embodiments described are just exemplary, and it will be understood that various changes may be made therein. For example, it will also be understood that when a layer is referred to as being “on” another layer or substrate, it can be directly on the other layer or substrate, or intervening layers may also be present. Each element of the inkjet printhead can be formed of a different material from the materials described in the exemplary embodiments. Furthermore, each element of the inkjet printhead can be formed using a stacking or forming method different from the illustrated one. In the method of forming the inkjet printhead according to the present general inventive concept, operations of the method can be performed in a different order from the illustrated order.

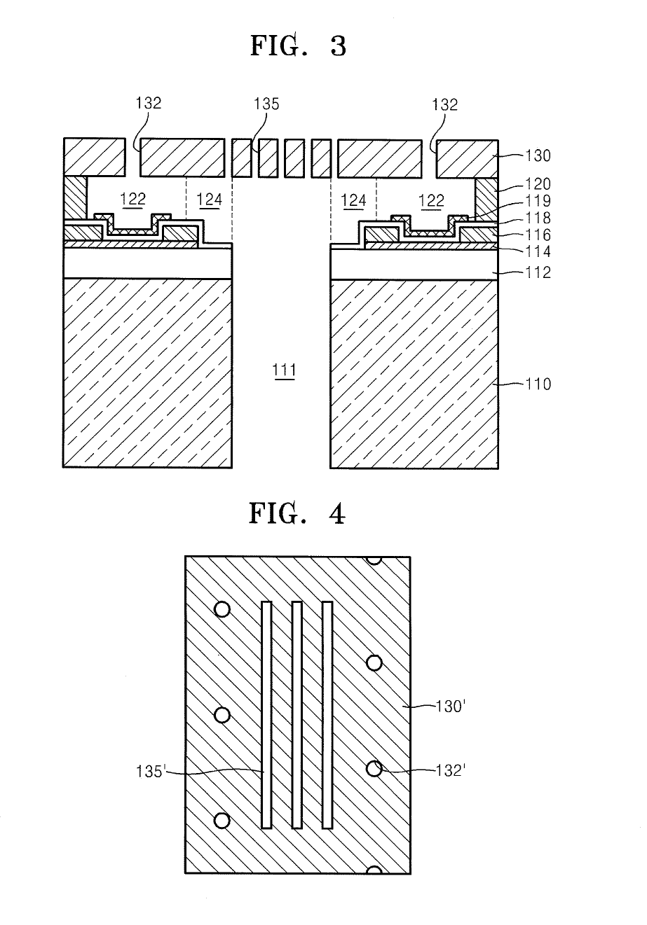

FIG. 2 is a schematic plan view illustrating an inkjet printhead according to an embodiment of the present general inventive concept, and FIG. 3 is a sectional view illustrating the inkjet taken along line III-III′ of FIG. 2.

Referring to FIGS. 2 and 3, the inkjet printhead according to this embodiment may include a substrate 110 on which a plurality of material layers are formed, a chamber layer 120 formed above the substrate 110, and a nozzle layer 130 formed on the chamber layer 120.

The substrate 110 may be formed of a silicon substrate. An ink feed hole 111 is formed in the substrate 110 to supply ink. The ink feed hole 111 can be formed through the substrate 110 in a perpendicular direction with respect to a surface of the substrate 110. An insulating layer 112 can be formed on the substrate 110 to thermally and electrically insulate the substrate 110 and the heaters 114 from each other. The insulating layer 112 may be formed of a silicon oxide. The heaters 114 can be formed on the insulating layer 112 to create ink bubbles by heating ink filled in ink chambers 122. The heaters 114 may be formed of a resistive heating material, such as a tantalum-aluminum alloy, a tantalum nitride, a titanium nitride, or a tungsten silicide. A plurality of electrodes 116 can be formed on each of the heaters 114 to apply a current to each of the heaters 114. The electrodes 116 are formed of a material having high electric conductivity, for example, aluminum (Al), an aluminum alloy, gold (Au), or silver (Ag).

Further, a passivation layer 118 may be formed on the heaters 114 and the electrodes 116. The passivation layer 118 prevents the heaters 114 and the electrodes 116 from oxidizing or corroding due to contact with ink. The passivation layer 118 may be formed of a silicon oxide or a silicon nitride. A plurality of anti-cavitation layers 119 may be further formed on a bottom surface of the ink chambers 122. That is, the anti-cavitation layers 119 may be formed on the passivation layer 118 above the heaters 114 and the electrodes 116. The anti-cavitation layers 119 protect the heaters 114 from cavitation forces generated when ink bubbles collapse. The anti-cavitation layers 119 may be formed of tantalum (Ta).

The chamber layer 120 can be formed on the passivation layer 118. The plurality of ink chambers 122 filled with ink supplied from the ink feed hole 111 are formed in the chamber layer 120. The ink chambers 122 are located above the heaters 114, respectively. Further, a plurality of restrictors 124 may be formed in the chamber layer 120 to connect the ink feed hole 111 with the ink chambers 122.

The nozzle layer 130 is formed on the chamber layer 120. The ink filled in the ink chambers 122 is ejected to the outside through a plurality of nozzles 132 of the nozzle layer 130. The nozzles 132 are located above the respective ink chambers 122. A diameter of each nozzle 132 may be approximately 12 μm, but the present general inventive concept is not limited thereto. A plurality of via holes 135 are formed through the nozzle layer 130. The via holes may be located above the ink feed hole 111. A diameter of each via hole 135 may be approximately from 2 to 15 μm, but is not limited thereto. The via holes 135 considerably reduce a development process time to form the nozzles 132 and the ink chambers 122 in manufacturing the inkjet printhead, as described later. Therefore, the inkjet printhead can be manufactured in less time due to the via holes 135 formed through the nozzle layer 130. In the current embodiment, each section of the via holes 135 is circular, but the present general inventive concept is not limited thereto, and the via holes 135 may have various shapes. For example, referring to FIG. 4, via holes 135′ of a slit-shape can be formed through a nozzle layer 130′ including nozzles 132′.

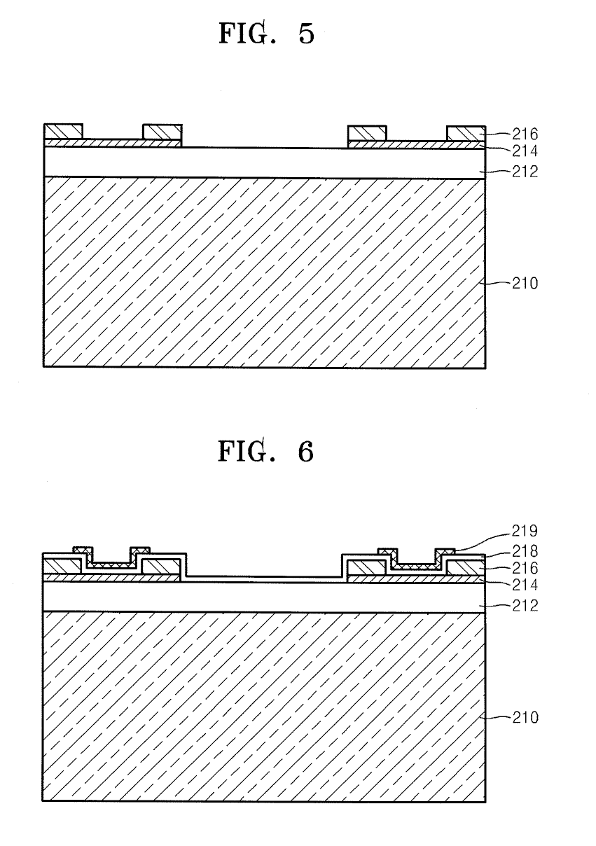

FIGS. 5 through 12 are views illustrating a method of manufacturing an inkjet printhead according to an embodiment of the present general inventive concept.

Referring to FIG. 5, a substrate 210 can be prepared. Generally, a silicon substrate may be used for the substrate 210. An insulating layer 212 is formed to a predetermined thickness on the substrate 210. The insulating layer 212 thermally and electrically insulates the substrate 210 and heaters, to be described later, from each other. The insulating layer 212 may be formed of a silicon oxide. Next, a plurality of heaters 214 are formed on the insulating layer 212 to generate ink bubbles by heating ink. A resistive heating material, such as a tantalum-aluminum alloy, a tantalum nitride, a titanium nitride, or a tungsten silicide, may be deposited on the insulating layer 212, and the deposited resistive heating material may be patterned to form the heaters 214. Electrodes 216 to apply a current to the heaters 214 are formed on each of the heaters 214. A metal having high electric conductivity, such as aluminum (Al), aluminum alloy, gold (Au), and silver (Ag), may be deposited on the heaters 214, and the deposited material may be patterned to form the electrodes 216.

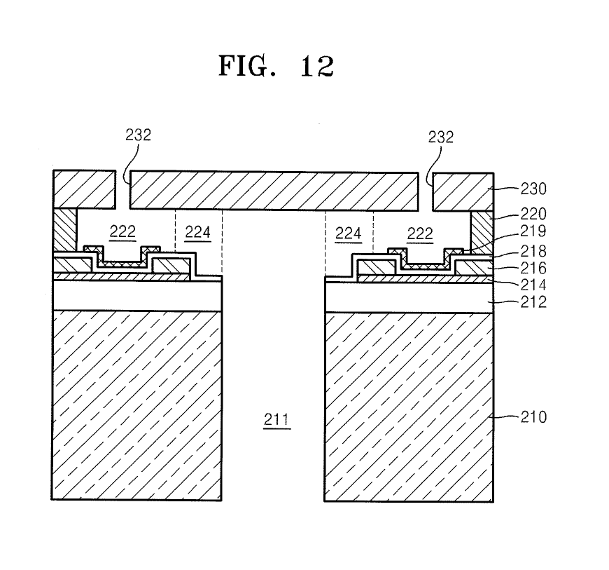

Referring to FIG. 6, a passivation layer 218 can be formed on the insulating layer 212 to cover the heaters 214 and the electrodes 216. The passivation layer 218 prevents the heaters 214 and the electrodes 216 from contacting the ink, thereby protecting the heaters 214 and the electrodes 216 against oxidization or corrosion. The passivation layer 218 may be formed of a silicon oxide or a silicon nitride. Anti-cavitation layers 219 are formed on bottom surfaces of ink chambers 222 (refer to FIG. 12) to be described later. That is, the anti-cavitation layers 219 can be formed on the passivation layer 218 above the respective heaters 214. The anti-cavitation layers 219 protect the heaters 214 from cavitation forces generated when ink bubbles collapse. For example, tantalum (Ta) may be deposited on the passivation layer 128 and then the deposited tantalum (Ta) may be patterned to form the anti-cavitation layers 219.

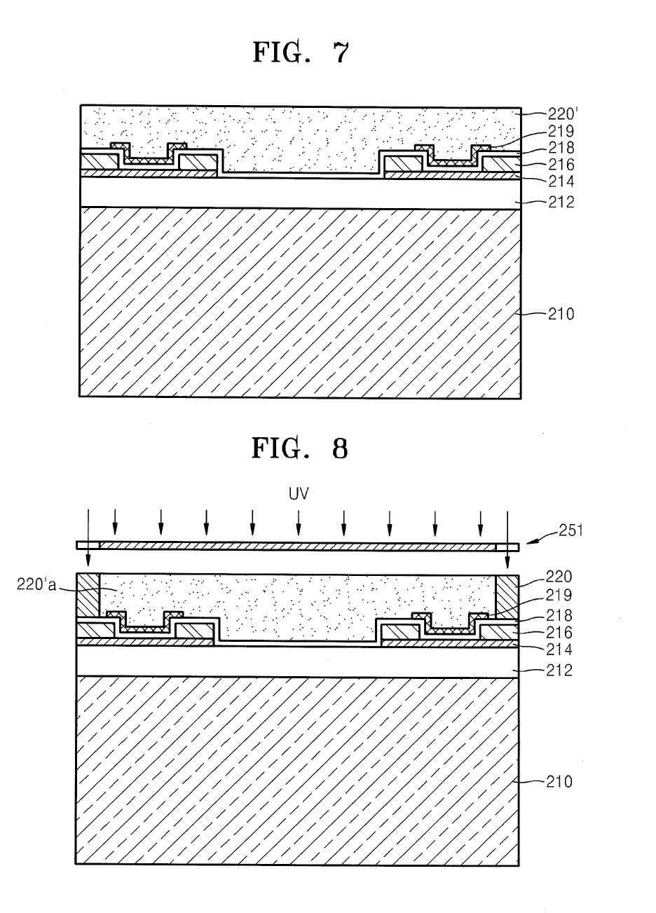

Referring to FIG. 7, a chamber material layer 220′ is formed to a predetermined thickness on a whole surface of the resulting structure illustrated in FIG. 6. The chamber material layer 220′ may be formed of a negative photoresist of which a non-exposed region can be removed with a developer.

Referring to FIG. 8, a first photomask 251 including an ink chamber pattern is disposed above the chamber material layer 220′, and then the chamber material layer 220′ is exposed using the first photomask 251. Then, a chamber layer 220 defining a plurality of ink chambers 222 (refer to FIG. 12) is formed in the chamber material layer 220′. Further, a plurality of restrictors 224 (refer to FIG. 12) may be defined by the chamber layer 220 to connect an ink feed hole 211 (refer to FIG. 12) with the ink chambers 222. Specifically, an exposed portion of the chamber material layer 220′ will be the chamber layer 220, and a non-exposed chamber material region 220′a of the chamber material layer 220′ will be removed with a developer in a development process, to be described later, to form the plurality of ink chambers 222.

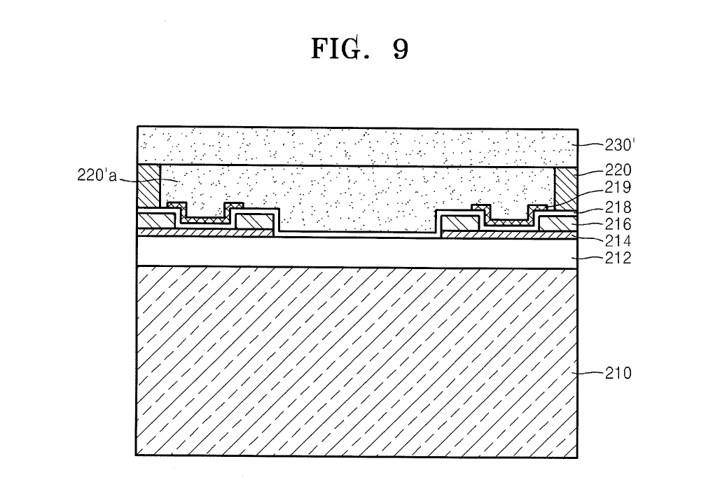

Referring to FIG. 9, after the exposure process of FIG. 8, a nozzle material layer 230′ is formed on the chamber layer 220 and the non-exposed chamber material region 220′a to a predetermined thickness. The nozzle material layer 230′ may be formed of a negative photoresist of which a non-exposed region is removed with a developer, as can also be the case of the aforementioned chamber material layer 220′ as described above.

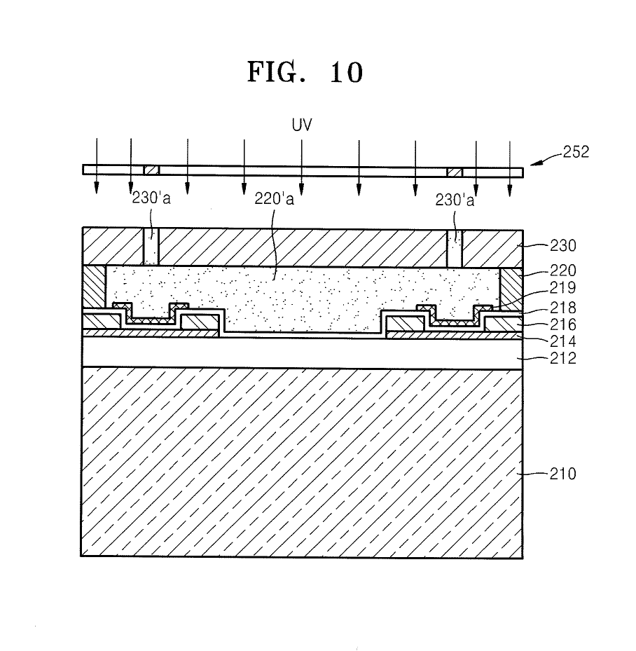

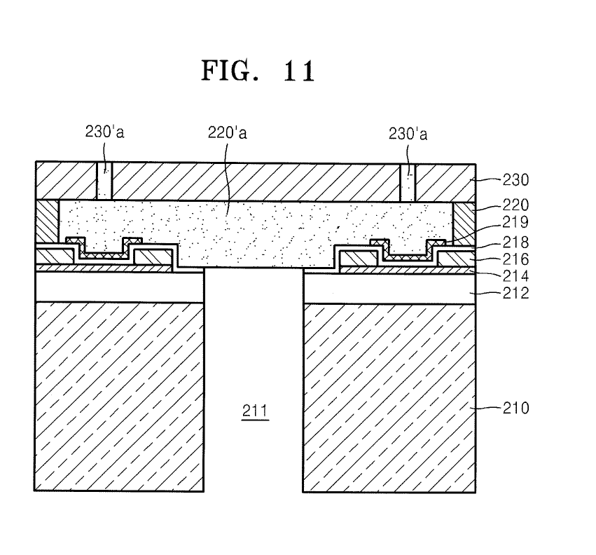

Referring to FIG. 10, a second photomask 252 including a nozzle pattern is disposed above the nozzle material layer 230′ and the nozzle material layer 230′ is exposed using the second photomask 252 for a predetermined time. Then, a nozzle layer 230 defining a plurality of nozzles 232 (refer to FIG. 12) is formed in the nozzle material layer 230′. Specifically, an exposed portion of the nozzle material layer 230′ will be the nozzle layer 230, and a non-exposed region 230′a of the nozzle material layer 230′ will be removed with a developer in a development process to be described later to form the plurality of nozzles 232. In the exposure process for the nozzle material layer 230′, when an exposure time is controlled such that only the nozzle material layer 230′ is exposed, it becomes easy to obtain the nozzle layer 230 and the chamber layer 220 of a desired thickness. Meanwhile, when the nozzle material layer 230′ is formed of a material having a little different light transmittance from the light transmittance of the chamber material layer 220′, it can be easier to obtain the nozzle layer 230 and the chamber layer 220 of a desired thickness.

Referring to FIG. 11, the substrate 210 is etched from its rear surface to form an ink feed hole 211 to supply ink. The ink feed hole 211 may be formed through the substrate 210 and the insulating layer 212 using etching such that a bottom surface of the non-exposed chamber material region 220′a is exposed. The ink feed hole 211 may be formed to a predetermined width, perpendicularly to a surface of the substrate 210. The ink feed hole 211 may be formed of various shapes, such as a shape tapered in an upward direction.

Referring to FIG. 12, the non-exposed nozzle material region 230′a in the nozzles 232 and the non-exposed chamber material region 220′a in the ink chambers 222 are removed with a developer. Accordingly, the plurality of ink chambers 222 are formed in the chamber layer 220, and the plurality of nozzles 232 are formed in the nozzle layer 230. Here, the ink chambers 222 are located above the respective heaters 214, and the nozzles 232 are located above the respective ink chambers 222. The plurality of restrictors 224 may be further formed in the chamber layer 220 to connect the ink feed hole 211 with the ink chambers 222.

In the above embodiment, the chamber material layer 220′ and the nozzle material layer 230′ are formed of a negative photoresist, but the general inventive concept is not limited thereto, and the chamber material layer 220′ and the nozzle material layer 230′ may be formed of a positive photoresist of which an exposed portion is removed with a developer. In this case, a non-exposed region of the chamber material layer 220′ will be the chamber layer 220, and an exposed portion of the chamber material layer 220′ will be removed with a developer to form the plurality of ink chambers 222. Also, a non-exposed region of the nozzle material layer 230′ will be the nozzle layer 230, and an exposed portion of the nozzle material layer 230′ will be removed with a developer to form the plurality of nozzles 232.

As described above, in the above embodiment, since the chamber layer 220 and the nozzle layer 230 can be formed using two exposure processes and one development process, the inkjet printhead can be manufactured using a simplified process.

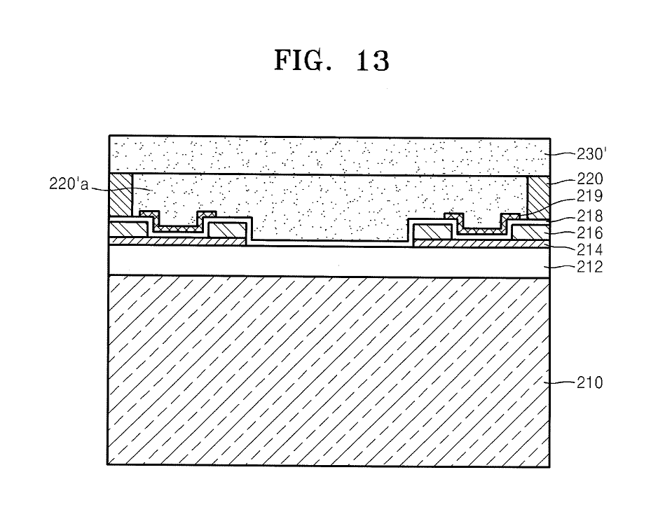

Hereinafter, a method of manufacturing an inkjet printhead will now be described according to another embodiment of the present general inventive concept. FIGS. 13 through 16 are views illustrating a method of manufacturing an inkjet printhead according to another embodiment of the present general inventive concept. Hereinafter, aspects different from the embodiment of FIGS. 5 through 12 will be mainly described. The processes illustrated with reference to FIGS. 5 through 9 are similar to the above embodiment, and thus drawings and specific descriptions thereof will be omitted. FIG. 13 is the same view as FIG. 9.

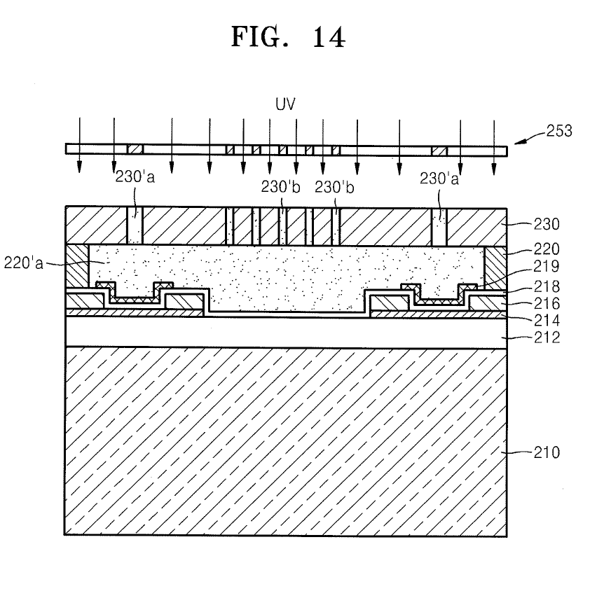

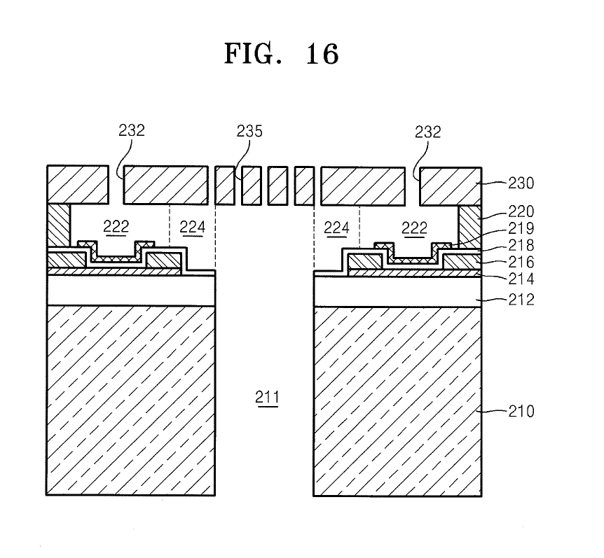

Referring to FIG. 14, a second photomask 253 including a nozzle pattern and a via hole pattern is disposed above the nozzle material layer 230′, and then the nozzle material layer 230′ is exposed using the second photomask 253 for a predetermined time. Then, a nozzle layer 230 defining a plurality of nozzles 232 (refer to FIG. 16) and a plurality of via holes 235 (refer to FIG. 16) is formed in the nozzle material layer 230′. Specifically, an exposed portion of the nozzle material layer 230′ will be the nozzle layer 230, and a non-exposed region, that is, a nozzle material layer 230′a in the nozzles 232 and a nozzle material layer 230′b in the via holes 235 will be removed with a developer in a development process to form the plurality of nozzles 232 and the plurality of via holes 235.

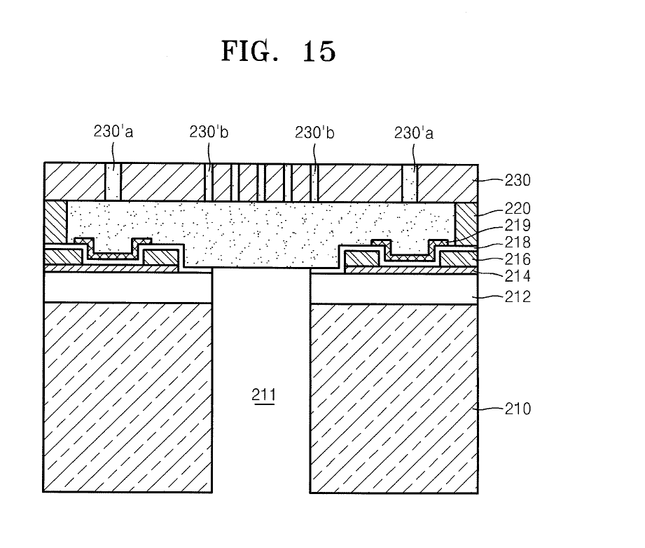

Referring to FIG. 15, the substrate 210 is etched from its rear surface to form an ink feed hole 211 to supply ink. The ink feed hole 211 may be formed through the substrate 210 and the insulating layer 212 using etching, such that a bottom surface of the non-exposed chamber material region 220′a is exposed.

Referring to FIG. 16, the non-exposed nozzle material regions 230′a and 230′b in the nozzles 232 and the via holes 235 and the non-exposed chamber material region 220′a in the ink chambers 222 are removed with a developer. Here, since the developer flowing in through the via holes 235 as well as the nozzles 232 and the ink feed holes 211 removes the non-exposed chamber material region 220′a, a development process time is reduced, compared to the embodiment of FIGS. 5 through 12, thus reducing a manufacturing time of the inkjet printhead. The plurality of ink chambers 222 are formed in the chamber layer 220 and the plurality of nozzles 232 and the plurality of via holes 235 are formed in the nozzle layer 230 through the development process. Meanwhile, the plurality of restrictors 224 may be further formed in the chamber layer 220 to connect the ink feed hole 211 with the ink chambers 222.

In the current embodiment, the chamber material layer 220′ and the nozzle material layer 230′ are formed of a negative photoresist, but may be formed of a positive photoresist of which an exposed portion is removed with a developer.

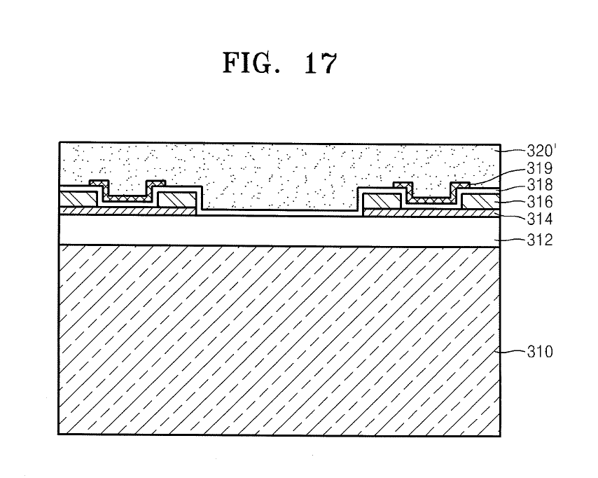

FIGS. 17 through 22 are views illustrating a method of manufacturing an inkjet printhead according to another embodiment of the present general inventive concept. Hereinafter, aspects different from the above-described embodiments will be mainly described. The processes illustrated with reference to FIGS. 5 and 6 are the same in the current embodiment, and thus drawings and specific descriptions thereof will be omitted.

Referring to FIG. 17, a chamber material layer 320′ is formed to a predetermined thickness on a whole surface of the resulting structure illustrated in FIG. 6. The chamber material layer 320′ may be formed of a negative photoresist of which a non-exposed region is removed with a developer. In FIG. 17, reference numerals 310, 312, 314, 316, 318, and 319 represent a substrate, an insulating layer, heaters, electrodes, a passivation layer, and anti-cavitation layers, respectively.

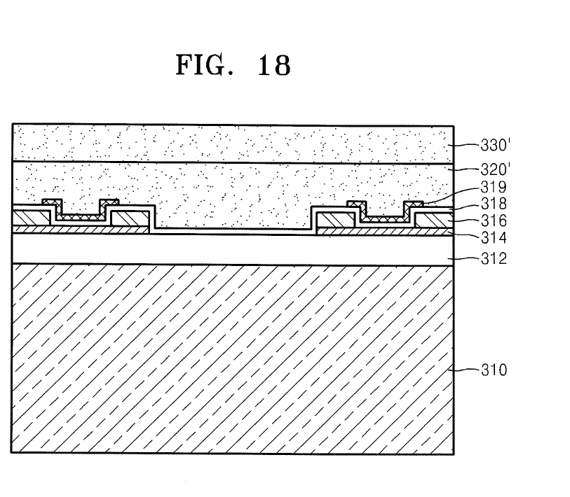

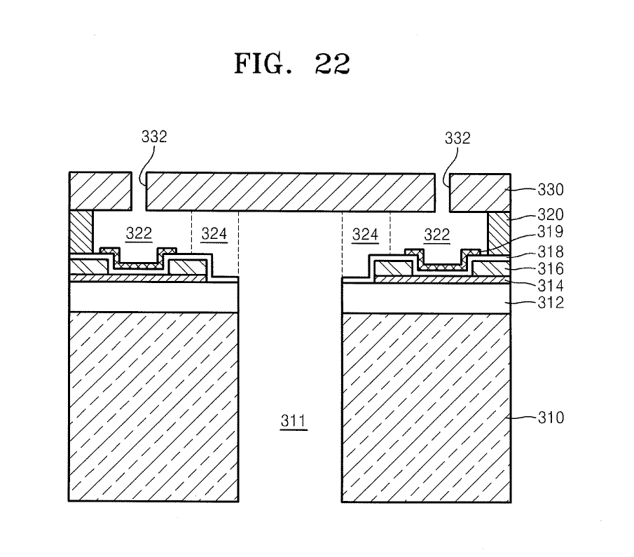

Referring to FIG. 18, a nozzle material layer 330′ is formed to a predetermined thickness on the chamber material layer 320′. The nozzle material layer 330′ may be formed of a negative photoresist. Meanwhile, when the nozzle material layer 330′ is formed of a material having a little different light transmittance with the transmittance of the chamber material layer 320′, it becomes easy to obtain a nozzle layer 330 (refer to FIG. 22) and a chamber layer 320 (refer to FIG. 22) of a desired thickness. Further, a light transmission restricting layer (not illustrated) may be formed on the chamber material layer 320′ before forming the nozzle material layer 330′. Since the light transmission restricting layer interposed between the nozzle material layer 330′ and the chamber material layer 320′ restricts the transmission of an ultraviolet ray, it becomes easier to obtain the nozzle layer 330 and the chamber layer 320 of a desired thickness.

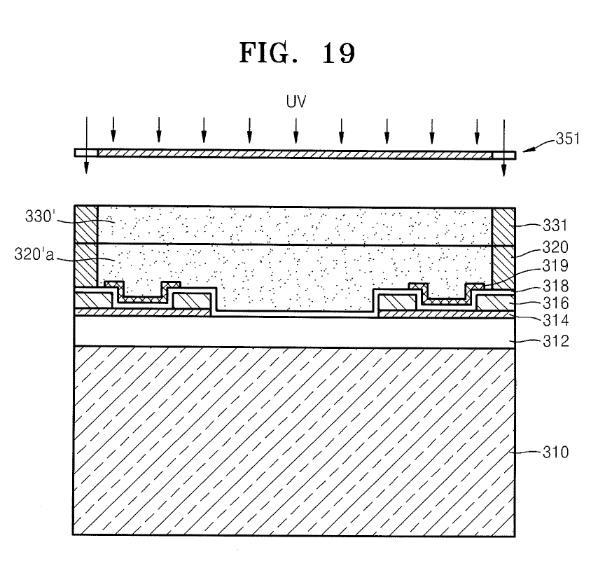

Referring to FIG. 19, a first photomask 351 including an ink chamber pattern is disposed above the nozzle material layer 330′, and then the nozzle material layer 330′ and the chamber material layer 220′ are exposed using the first photomask 351. Then, a chamber layer 320 defining a plurality of ink chambers 322 (refer to FIG. 22) is formed in the chamber material layer 320′ under the nozzle material layer 330′. Specifically, an exposed portion of the chamber material layer 320′ will be the chamber layer 320, and a non-exposed region 320′a of the chamber material layer 320′ will be removed with a developer in a development process to be described later to form the plurality of ink chambers 322. Further, a plurality of restrictors 324 (refer to FIG. 22) may be formed in the chamber layer 320 to connect an ink feed hole 311 (refer to FIG. 22) with the ink chambers 322. An exposed portion 331 of the nozzle material layer 330′ will have the same shape as the chamber layer 320.

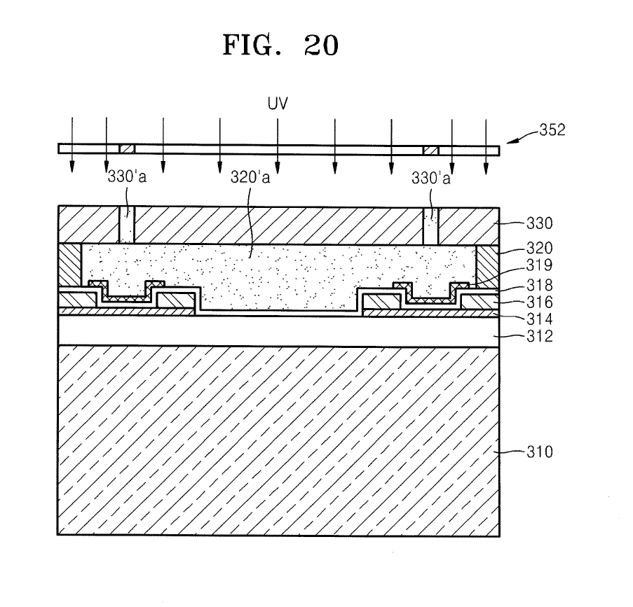

Referring to FIG. 20, a second photomask 352 including a nozzle pattern is disposed above the nozzle material layer 330′ where the exposure process is performed, and the nozzle material layer 330′ is exposed using the second photomask 352. Then, a nozzle layer 330 defining a plurality of nozzles 332 (refer to FIG. 22) is formed in the nozzle material layer 330′. Specifically, an exposed portion of the nozzle material layer 330′ will be the nozzle layer 330, and a non-exposed region 330′a of the nozzle material layer 330′ will be removed with a developer in a development process to be described later to form the plurality of nozzles 332. In the exposure process for the nozzle material layer 330′, when an exposure time is controlled such that only the nozzle material layer 330 is exposed, it becomes easy to obtain the nozzle layer 330 and the chamber layer 320 of a desired thickness. Meanwhile, when the nozzle material layer 330′ is formed of a material having a little different light transmittance from the light transmittance of the chamber material layer 320′, it becomes easy to obtain the nozzle layer 330 and the chamber layer 320 of a desired thickness. Further, when a light transmission restricting layer (not illustrated) may be formed on the chamber material layer 320′ before forming the nozzle material layer 330′, it becomes easier to obtain the nozzle layer 330 and the chamber layer 320 of a desired thickness.

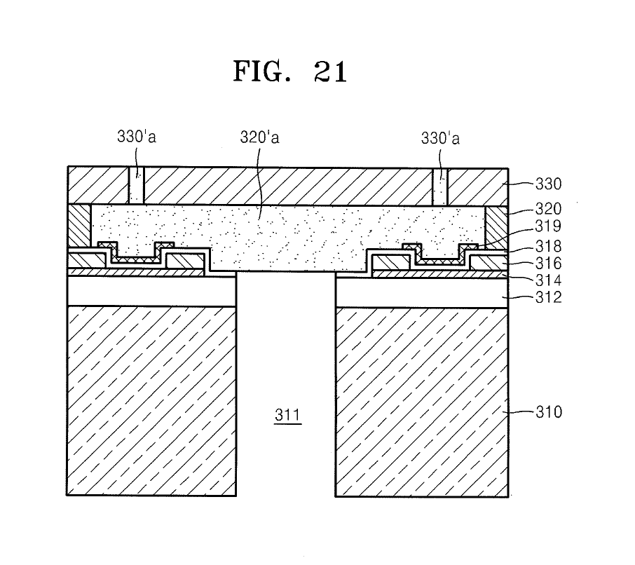

Referring to FIG. 21, the substrate 310 is etched from its rear surface to form an ink feed hole 311 to supply ink. The ink feed hole 311 may be formed through the substrate 310 and the insulating layer 312 using etching such that a bottom surface of the non-exposed chamber material region 320′a is exposed.

Referring to FIG. 22, the non-exposed nozzle material regions 330′a in the nozzles 332 and the non-exposed chamber material region 320′a in the ink chambers 322 are removed with a developer. Then, the plurality of ink chambers 322 are formed in the chamber layer 320, and the plurality of nozzles 332 are formed in the nozzle layer 330. Meanwhile, a plurality of restrictors 324 may be further formed to connect the ink feed hole 311 with the ink chambers 322.

In the above embodiment, the chamber material layer 320′ and the nozzle material layer 330′ are formed of a negative photoresist, but may also be formed of a positive photoresist of which an exposed portion is removed with a developer.

As described above, in the above embodiment, since the chamber layer 320 and the nozzle layer 330 can be formed using two exposure processes and one development process, the inkjet printhead can be manufactured using a simplified process.

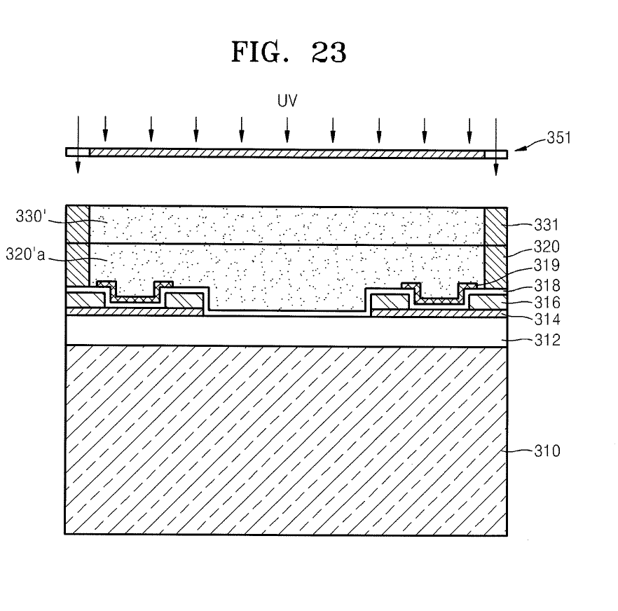

FIGS. 23 through 26 are views illustrating a method of manufacturing an inkjet printhead according to another embodiment of the present general inventive concept. Hereinafter, aspects different from the above-described embodiments will be mainly described. The processes illustrated with reference to FIGS. 17 through 19 are similar in this embodiment, and thus drawings and specific descriptions thereof will be omitted. FIG. 23 is the same as FIG. 19.

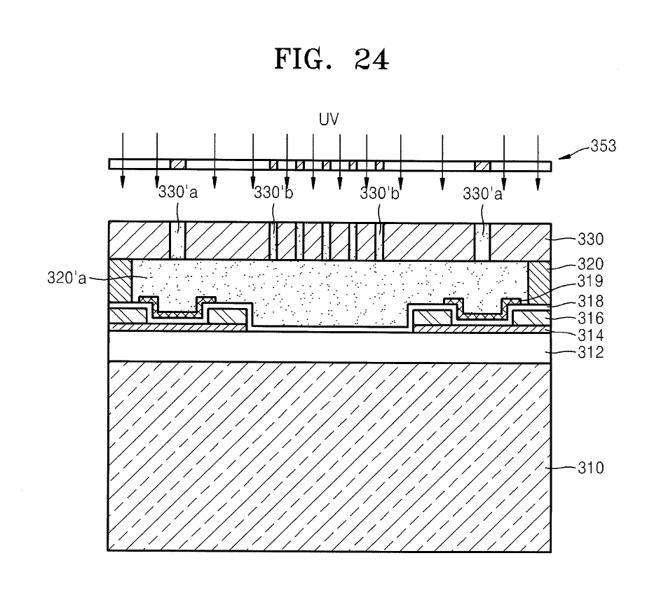

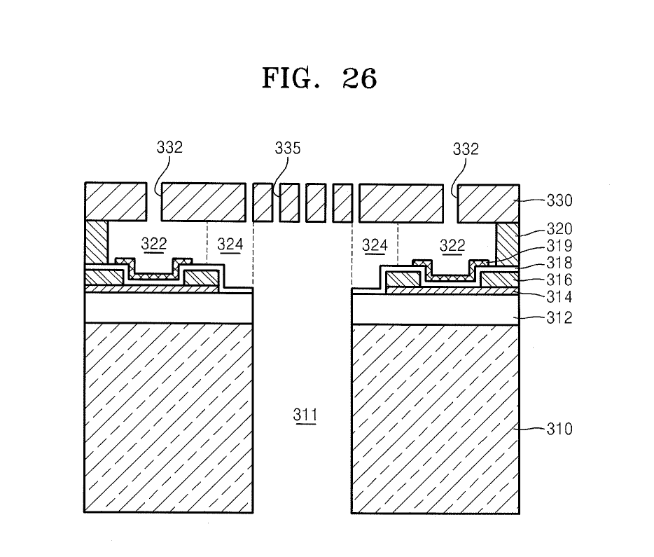

Referring to FIG. 24, a second photomask 353 including a nozzle pattern and a via hole pattern is disposed above the nozzle material layer 330′ where the exposure process is performed, and the nozzle material layer 330′a is exposed using the second photomask 353. Then, a nozzle layer 330 defining a plurality of nozzles 332 (refer to FIG. 26) and a plurality of via holes 335 (refer to FIG. 26) is formed in the nozzle material layer 330′. Specifically, an exposed portion of the nozzle material layer 330′ will be the nozzle layer 330, and a non-exposed region of the nozzle material layer 330′, that is, a nozzle material layer 330′a in the nozzles 332 and a nozzle material layer 330′b in the via holes 335 will be removed with a developer in a development process to form the plurality of nozzles 332 and the plurality of via holes 335.

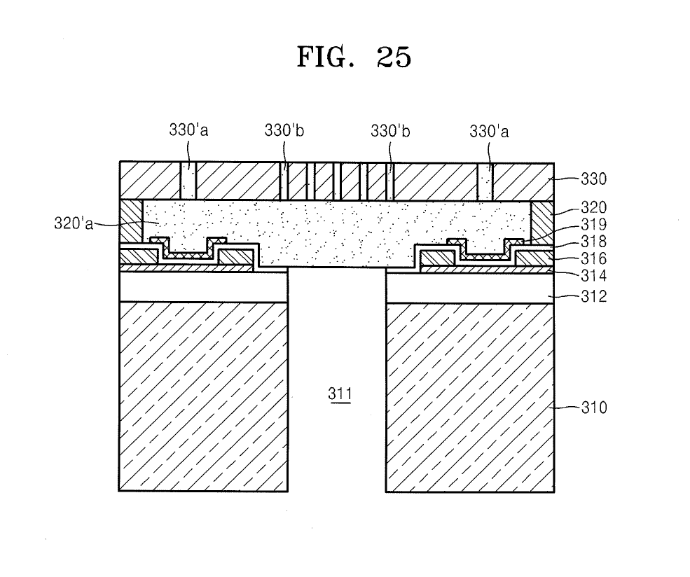

Referring to FIG. 25, the substrate 310 is etched from its rear surface to form an ink feed hole 311 for supplying ink. The ink feed hole 311 may be formed through the substrate 310 and an insulating layer 324 using etching such that a bottom surface of the non-exposed chamber material region 320′a is exposed.

Referring to FIG. 26, the non-exposed nozzle material regions 330′a and 330′b in the nozzles 332 and the via holes 335 and the non-exposed chamber material region 320′a in the ink chambers 322 are removed with a developer. Here, since a developer flowing in through the via holes 335 as well as the nozzles 332 and the ink feed holes 311 removes the non-exposed chamber material region 320′a, a development process time can be reduced, thus reducing the manufacturing time of the inkjet printhead. The plurality of ink chambers 322 are formed in the chamber layer 320 and the plurality of nozzles 332 and the plurality of via holes 335 are formed in the nozzle layer 330 through the development process. Meanwhile, a plurality of restrictors 324 may be further formed in the chamber layer 320 to connect the ink feed hole 311 with the ink chambers 322.

In this embodiment, the chamber material layer 320′ and the nozzle material layer 330′ are formed of a negative photoresist, but may also be formed of a positive photoresist of which an exposed portion is removed with a developer.

As described above, according to the present general inventive concept, a chamber layer and a nozzle layer are formed through two exposure processes and one development process. Therefore, an inkjet printhead can be manufactured using a simplified process, compared to a conventional method that requires forming of a sacrificial layer and a CMP process, thus reducing a manufacturing time. Also, when a plurality of via holes are formed in the nozzle layer, the manufacturing time of the inkjet printhead can be reduced even more.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
a substrate through which an ink feed hole to supply ink is formed;
a chamber layer stacked above the substrate and including a plurality of ink chambers filled with ink supplied from the ink feed hole; and
a nozzle layer stacked on the chamber layer, wherein a plurality of nozzles through which ink is ejected and a plurality of via holes are formed in the nozzle layer.

2. The inkjet printhead of claim 1, wherein the via holes are located above the ink feed hole.

3. The inkjet printhead of claim 1, wherein an insulating layer is formed on the substrate.

4. The inkjet printhead of claim 3, wherein:
a plurality of heaters are formed on the insulating layer to create bubbles by heating ink filled in the ink chambers; and
a plurality of electrodes are formed on the heaters to apply a current to the heaters.

5. The inkjet printhead of claim 4, wherein a passivation layer is formed on the heaters and the electrodes.

6. The inkjet printhead of claim 5, wherein a plurality of anti-cavitation layers are formed on the passivation layer above the heaters to protect the heaters from cavitation forces generated when the bubbles collapse.

7. The inkjet printhead of claim 1, wherein a plurality of restrictors are formed in the chamber layer to connect the ink feed hole with the ink chambers.

8. A method of manufacturing an inkjet printhead, the method comprising:
preparing a substrate;
forming a chamber material layer above the substrate;
disposing a first photomask including an ink chamber pattern above the chamber material layer and exposing the chamber material layer to form a chamber layer defining a plurality of ink chambers in the chamber material layer;
forming a nozzle material layer on the exposed chamber material layer;
disposing a second photomask including a nozzle pattern above the nozzle material layer and exposing the nozzle material layer to form a nozzle layer defining a plurality of nozzles in the nozzle material layer;
etching the substrate from a rear surface of the substrate such that a bottom surface of the chamber material layer is exposed to form an ink feed hole; and
removing the chamber material layer in the ink chambers and the nozzle material layer in the nozzles with a developer.

9. The method of claim 8, wherein the chamber material layer and the nozzle material layer are formed of a negative photoresist of which a non-exposed region is removed with a developer.

10. The method of claim 8, wherein the chamber material layer and the nozzle material layer are formed of a positive photoresist of which an exposed portion is removed with a developer.

11. The method of claim 8, wherein the preparing of the substrate comprises:
forming the substrate;
forming an insulating layer on the substrate;
forming a plurality of heaters on the insulating layer; and
forming a plurality of electrodes on the heaters.

12. The method of claim 11, wherein the preparing of the substrate further comprises:
forming a passivation layer to cover the heaters and the electrodes after the forming of the electrodes.

13. The method of claim 12, wherein the preparing of the substrate further comprises:
forming anti-cavitation layers on the passivation layer above the heaters after the forming of the passivation layer.

14. A method of manufacturing an inkjet printhead, the method comprising:
preparing a substrate;
forming a chamber material layer above the substrate;
disposing a first photomask including an ink chamber pattern above the chamber material layer and exposing the chamber material layer to form a chamber layer defining a plurality of ink chambers in the chamber material layer;
forming a nozzle material layer on the exposed chamber material layer;
disposing a second photomask including a nozzle pattern and a via hole pattern above the nozzle material layer and exposing the nozzle material layer to form a nozzle layer defining a plurality of nozzles and a plurality of via holes in the nozzle material layer;
etching the substrate from a rear surface of the substrate such that a bottom surface of the chamber material layer is exposed to form an ink feed hole; and
removing the chamber material layer in the ink chambers and the nozzle material layer in the nozzles and the via holes with a developer.

15. The method of claim 14, wherein the via holes are located above the ink feed hole.

16. A method of manufacturing an inkjet printhead, the method comprising:
preparing a substrate;
forming a chamber material layer above the substrate;
forming a nozzle material layer on the chamber material layer;
disposing a first photomask including an ink chamber pattern above the nozzle material layer and exposing the nozzle material layer and the chamber material layer to form a chamber layer defining a plurality of ink chambers in the chamber material layer;
disposing a second photomask including a nozzle pattern above the nozzle material layer and exposing the nozzle material layer to form a nozzle layer defining a plurality of nozzles in the nozzle material layer;
etching the substrate from a rear surface of the substrate such that a bottom surface of the chamber material layer is exposed to form an ink feed hole; and
removing the chamber material layer in the ink chambers and the nozzle material layer in the nozzles with a developer.

17. The method of claim 16, wherein the chamber material layer and the nozzle material layer are formed of a negative photoresist of which a non-exposed region is removed with a developer.

18. The method of claim 16, wherein the chamber material layer and the nozzle material layer are formed of a positive photoresist of which an exposed portion is removed with a developer.

19. The method of claim 16, wherein the preparing of the substrate comprises:
forming the substrate;
forming an insulating layer on the substrate;
forming a plurality of heaters on the insulating layer; and
forming a plurality of electrodes on the heaters.

20. The method of claim 19, wherein the preparing of the substrate further comprises:
forming a passivation layer to cover the heaters and the electrodes after the forming of the electrodes.

21. The method of claim 20, wherein the preparing of the substrate further comprises:
forming anti-cavitation layers on the passivation layer above the heaters after the forming of the passivation layer.

22. The method of claim 16, further comprising:
forming a light transmission restricting layer on the chamber material layer after the forming of the chamber material layer and before the forming of the nozzle material layer.

23. A method of manufacturing an inkjet printhead, the method comprising:
preparing a substrate;
forming a chamber material layer above the substrate;
forming a nozzle material layer on the chamber material layer;
disposing a first photomask including an ink chamber pattern above the nozzle material layer and exposing the nozzle material layer and the chamber material layer to form a chamber layer defining a plurality of ink chambers in the chamber material layer;
disposing a second photomask including a nozzle pattern and a via hole pattern above the nozzle material layer and exposing the nozzle material layer to form a nozzle layer defining a plurality of nozzles and a plurality of via holes in the nozzle material layer;
etching the substrate from a rear surface of the substrate such that a bottom surface of the chamber material layer is exposed to form an ink feed hole; and
removing the chamber material layer in the ink chambers and the nozzle material layer in the nozzles and the via holes with a developer.

24. The method of claim 23, wherein the via holes are located above the ink feed hole.

25. A method of manufacturing an inkjet printhead, the method comprising:
preparing a substrate;
forming a chamber material layer on the substrate;
forming a nozzle material layer above the chamber material layer;
exposing the chamber material layer and the nozzle material layer to form a chamber layer and a nozzle layer respectively;
etching the substrate to form an ink feed hole; and
removing excess chamber material layer and nozzle material layer with a single development process to form ink chambers and nozzles.

26. The method of claim 25, wherein the exposing of the chamber material layer and the nozzle material layer comprises:
disposing a first photomask above the chamber material layer and exposing the chamber material layer to form a chamber layer defining a plurality of ink chambers, and
disposing a second photomask above the nozzle material layer and exposing the nozzle material layer to form a nozzle layer defining a plurality of nozzles; and
the nozzle material layer is formed above the exposed chamber material layer.

27. The method of claim 25, wherein the exposing of the chamber material layer and the nozzle material layer comprises:
disposing a first photomask above the nozzle material layer and exposing the nozzle material layer and the chamber material layer to form a chamber layer defining a plurality of ink chambers in the chamber material layer; and
disposing a second photomask above the nozzle material layer and exposing the nozzle material layer to form a nozzle layer defining a plurality of nozzles.

28. The method of claim 27, wherein a time of exposure is controlled such that only the nozzle material is exposed when exposing the nozzle material layer to form a nozzle layer defining a plurality of nozzles.

29. The method of claim 27, wherein a light transmittance of the nozzle material layer and the chamber material layer is such that only the nozzle material is exposed when exposing the nozzle material layer to form a nozzle layer defining a plurality of nozzles.

30. The method of claim 26, wherein the exposing of the nozzle material layer to form a nozzle layer defining a plurality of nozzles also defines a plurality of via holes between the nozzles.

31. The method of claim 30, wherein the plurality of via holes are formed above the ink feed hole to allow faster removal of the excess nozzle material layer and chamber material layer.

32. The method of claim 27, wherein the exposing of the nozzle material layer to form a nozzle layer defining a plurality of nozzles also defines a plurality of via holes to allow faster removal of the excess nozzle and chamber material layer during the development process.

33. The method of claim 25, wherein the preparing of the substrate comprises:
forming the substrate;
forming an insulating layer on the substrate;
forming a plurality of heaters on the insulating layer; and
forming a plurality of electrodes on the heaters.

34. A method of manufacturing an inkjet printhead, the method comprising:
preparing a substrate;
forming a chamber material layer having a first light transmittance on the substrate;
forming a nozzle material layer having a second light transmittance above the chamber material layer;
exposing the chamber material layer and the nozzle material layer to form a chamber layer and a nozzle layer respectively;
etching the substrate to form an ink feed hole; and
removing excess chamber material layer and nozzle material layer with a single development process to form ink chambers and nozzles.

35. The method of claim 34, wherein:
the exposing of the chamber material layer and the nozzle material layer comprises:
disposing a first photomask above the nozzle material layer and exposing the nozzle material layer and the chamber material layer to form a chamber layer defining a plurality of ink chambers in the chamber material layer, and
disposing a second photomask above the nozzle material layer and exposing the nozzle material layer to form a nozzle layer defining a plurality of nozzles; and
a time of exposure is controlled such that only the nozzle material is exposed when exposing the nozzle material layer to form a nozzle layer defining a plurality of nozzles.
